(19) United States
(12) Patent Application Publication
(10) Pub. No.: US 2025/0211923 A1
(43) Pub. Date: Jun. 26, 2025

(54) PROXIMITY SENSOR USED FOR FEEDBACK CANCELLATION ADJUSTMENT IN A HEARING DEVICE

(71) Applicant: Starkey Laboratories, Inc., Eden Prairie, MN (US)

(72) Inventors: Parth Mishra, The Colony, TX (US); Henning Schepker, Oldenburg (DE); Kyle Olson, St. Louis Park, MN (US)

(21) Appl. No.: 18/987,948

(22) Filed: Dec. 19, 2024

Related U.S. Application Data
(60) Provisional application No. 63/612,684, filed on Dec. 20, 2023.

(51) Int. Cl. H04R 25/00

(52) U.S. Cl. CPC H04R 25/453; H04R 25/604; H04R 25/609; H04R 2430/01

(57) ABSTRACT

A hearing device includes a receiver, a microphone, and a proximity sensor operable to detect a proximate object. One or more processors are coupled to the receiver, the microphone, and the proximity sensor. The processors are operable to execute a feedback canceller that cancels feedback transmitted through a feedback path between the receiver and the microphone. The processors are further operable to detect, via the proximity sensor, a relative movement between the object and the hearing device, and in response thereto, adjust a parameter affecting the feedback canceller of the hearing device to compensate for a change caused by the relative movement that affects the feedback canceller, such as a change in the feedback path.

### RELATED PATENT DOCUMENTS

This application claims the benefit of U.S. Provisional Application No. 63/612,684 filed on Dec. 20, 2023, which is incorporated herein by reference in its entirety.

### SUMMARY

This application relates generally to ear-level electronic systems and devices, including hearing aids, personal amplification devices, and hearables. In one embodiment, a hearing device includes a receiver, a microphone, and a proximity sensor operable to detect a proximate object. One or more processors are coupled to the receiver, the microphone, and the proximity sensor. The processors are operable to execute a feedback canceller that cancels feedback transmitted through a feedback path between the receiver and the microphone. The processors are further operable to detect, via the proximity sensor, a relative movement between the object and the hearing device, and in response thereto, adjust a parameter affecting the feedback canceller of the hearing device to compensate for a change caused by the relative movement that affects the feedback canceller.

In another embodiment, a method of operating a hearing device involves detecting, via a proximity sensor of the hearing device, a relative movement between an object and the hearing device. The proximity sensor is operable to detect objects proximate to but not in contact with the hearing device. The method further involves determining that the relative movement will microphone affecting a feedback canceller of the hearing device, the feedback canceller used to cancel feedback that is transmitted through a feedback path. In in response thereto, the method further involves adjusting a parameter affecting the feedback canceller of the hearing device to compensate for the relative movement. The figures and the detailed description below more particularly exemplify illustrative embodiments.

### BRIEF DESCRIPTION OF THE DRAWINGS

The discussion below makes reference to the following figures.

FIG. 1 is an illustration of a hearing device in an ear according to an example embodiment;

FIG. 2 is a block diagram showing a proximity detector used in a hearing device according to an example embodiment;

FIGS. 3 and 4 show potential locations for proximity sensors in hearing devices according to example embodiments;

FIG. 5 is a block diagram of an audio and feedback processing path according to an example embodiment;

FIG. 6 is a flowchart of a method according to an example embodiment;

FIGS. 7 and 8 are block diagrams illustrating training and structure of a machine learning model according to example embodiments;

FIG. 9 is a block diagram of a hearing device and system according to an example embodiment; and

FIG. 10 is a flowchart of a method according to another example embodiment.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments disclosed herein are directed to an ear-worn or ear-level electronic hearing device. Such a device may include cochlear implants and bone conduction devices, without departing from the scope of this disclosure. The devices depicted in the figures are intended to demonstrate the subject matter, but not in a limited, exhaustive, or exclusive sense. Ear-worn electronic devices (also referred to herein as “hearing aids,” “hearing devices,” and “ear-wearable devices”), such as hearables (e.g., wearable earphones, ear monitors, and earbuds), hearing aids, hearing instruments, and hearing assistance devices, typically include an enclosure, such as a housing or shell, within which internal components are disposed.

Embodiments described herein relate to managing feedback in an ear-wearable device. Feedback occurs when amplified sound from a hearing aid's speaker inadvertently loops back into the microphone, resulting in disruptive high-pitched distortions known as chirping or howling. Countering feedback can be complex due to the interplay between the microphone, amplifier, and the user's environment, leading to reduction in hearing aid effectiveness, e.g., the maximum stable gain that can be applied. Feedback can be challenging to manage for example when there are sudden changes in the feedback path. Feedback poses a challenge in hearing aid technology because it can limit amplification capabilities and degrade sound quality. A hearing device may include a feedback canceller that reduces or eliminates the negative effects of feedback, helping to ensure good performance and user satisfaction.

A hearing device often works in a changing acoustic environment. For example, objects such as hats, helmets, hair, phones, glasses, pillows, etc. may come near to or in contact with the ear at various times and then move away at other times. These objects can cause a change in feedback path such that a feedback cancelling circuit may not be able to adapt or compensate. Unexpected external conditions may be encountered that cause a similar effect, such as commuting on public transportation, crowded rooms, riding in a vehicle, etc. In this disclosure, a hearing device is described that can more quickly adapt to changes in the system, ultimately enhancing feedback cancelling performance of the hearing device.

A feedback canceller algorithm may model the acoustic feedback path using an adaptive filter that is subsequently used to provide an estimate of the acoustic feedback in the microphone. This estimate is then subtracted from the microphone to provide a feedback free signal that is used for further processing (e.g., amplification, noise reduction, etc.) in the hearing aid. One challenge for such adaptive filter is the appropriate choice of the step-size which trades off between a) slow adaptation to changes in the acoustic feedback path but good modelling accuracy in unchanged acoustics paths and b) fast adaptation to changes in the acoustic feedback path but less accurate modelling in unchanged acoustic paths. Thus, adapting the step-size dynamically is desirable. However, audio signal-based automatic adaptations of the step-size often suffer from the so-called bias problem, induced by the self-correlation of the desired audio signal in the hearing aid microphone.

Embodiments described below can enhance the performance of hearing aids by integrating proximity sensors to detect objects near the device. One goal of this approach is to mitigate feedback-related issues, commonly known as chirping, that can occur due to obstructions in the acoustic feedback path or other causes other changes that affect the feedback canceller. By detecting the presence of objects near the head and/or ears using one or multiple proximity sensor(s) the proposed system aims to dynamically adapt the feedback cancellation (FBC) algorithm to prevent the occurrence of feedback-related issues and improve the overall user experience.

In embodiments described below, a hearing device incorporates one or more proximity sensors. The proximity sensors may be located on one or both of in-the-ear and outside-the-ear components of the hearing device. These sensors provide real-time insights into the proximity of objects relative to the hearing aid, thereby facilitating real-time analysis of changes in the feedback path. Consequently, the FBC algorithm can be instantaneously calibrated to counterbalance potential feedback disturbances arising from detected obstructions. This adaptability ensures not only clearer but also more comfortable sound reception for individuals using hearing aids.

In addition to providing information about nearby objects, the proximity sensors can be used for real-time monitoring. Such real-time monitoring functionality offers insights into the movement of the hearing aid in relation to the user's head. For example, if the receiver part of the hearing aid shifts slightly out of the ear canal, or if the behind the ear (BTE) module is not properly positioned due to factors like eyewear or headwear, it can cause changes in the feedback path, potentially impacting the quality of sound. Detecting the positioning of the hearing aid enables the system to account for such changes, thereby ensuring the continued effectiveness of the feedback cancellation algorithm even when the hearing aid is in (or moving between) different positions.

In some embodiments, the sound processing circuitry uses signals from a proximity sensor to detect objects impacting the feedback canceller, enabling quick responses to changing auditory contexts. Secondly, such a system can allow for improved performance in dynamically adjusting the FBC algorithm in direct response to identified feedback path variations. This adaptability can mitigate undesirable artifacts, thus optimizing the user experience. This can help ensure an improved sound quality with fewer feedback-induced interruptions.

Note that in this disclosure, a change in feedback path change is described as being detected via a proximity sensor, and the change in feedback path is used to adjust the feedback canceller. However, an explicit calculation of feedback path changes is not required. For some models, such as machine learning models, the correlation between movement of a proximate object and resulting changes to feedback canceller performance is empirically derived, and the changes may also be due to other interactions not envisioned in a purely acoustic coupling model. For example, a changing magnetic field caused by movement of a nearby magnetic object may affect electrical performance of the device, which can impact the FBC without affecting the feedback path. Therefore, where apparatuses, systems, and methods are described hereinbelow as detecting feedback path changes via a proximity sensor, it will be understood that the proximity sensor information may be detecting other phenomena that does not necessarily change the feedback path, but that could affect the feedback canceller nonetheless and can be used in a similar manner to compensate.

In some embodiments, the proximity sensor signals can be used to automatically switch the hearing aid on when (properly) inserted or off when being removed. This can involve removing power from certain circuits or disabling audio processing while power remains on. This function can eliminate feedback during both insertion and removal, accomplishing this by muting the audio output for example. This not only enhances user convenience but also eliminates potential discomfort caused by abrupt feedback occurrences during these moments.

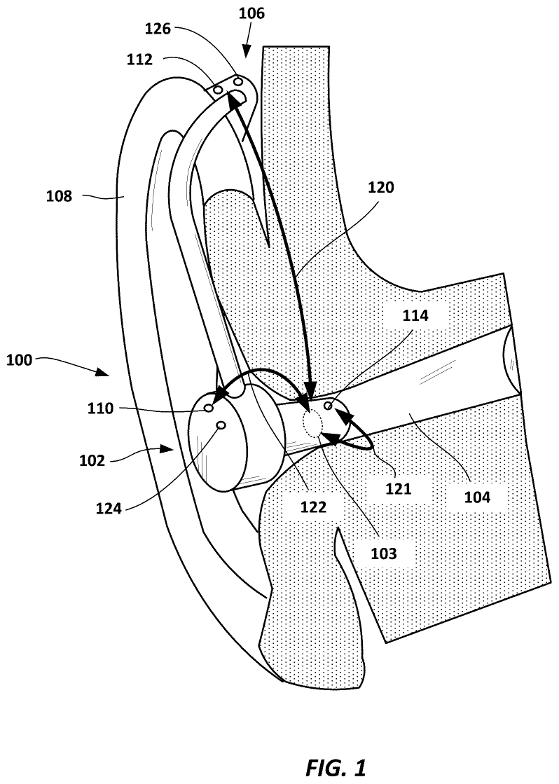

In FIG. 1, a diagram illustrates an example of an ear-wearable device 100 according to an example embodiment. The ear-wearable device 100 includes an in-ear portion 102 that fits into the ear canal 104 of a user/wearer. The ear-wearable device 100 may also include an external portion 106, e.g., worn over the back of the outer ear 108. The external portion 106 is electrically and/or acoustically coupled to the internal portion 102. The in-ear portion 102 may include an acoustic transducer 103, although in some embodiments the acoustic transducer may be in the external portion 106, where it is acoustically coupled to the ear canal 104, e.g., via a tube. The acoustic transducer 103 may be referred to herein as a “receiver,” “loudspeaker,” etc., and could include a bone conduction transducer. One or both portions 102, 106 may include an external microphone, as indicated by respective microphones 110, 112. If the device has an external portion 106, it may have two microphones 112 (e.g., front and rear microphones).

The device 100 may also include an internal microphone 114 that detects sound inside the ear canal 104. The internal microphone 114 may also be referred to as an inward-facing microphone or error microphone. Other components of hearing device 100 not shown in the figure may include a processor (e.g., a digital signal processor or DSP), memory circuitry, power management and charging circuitry, one or more communication devices (e.g., one or more radios, a near-field magnetic induction (NFMI) device), one or more antennas, buttons and/or switches, for example. The hearing device 100 can incorporate a long-range communication device, such as a Bluetooth® transceiver or other type of radio frequency (RF) transceiver.

While FIG. 1 shows one example of a hearing device, often referred to as a hearing aid (HA), the term hearing device of the present disclosure may refer to a wide variety of ear-level electronic devices that can aid a person with or without impaired hearing. This includes devices that can produce processed sound for persons with normal hearing, such as noise addition/cancellation to treat misophonia. Hearing devices include, but are not limited to, behind-the-ear (BTE), in-the-ear (ITE), in-the-canal (ITC), invisible-in-canal (IIC), receiver-in-canal (RIC), receiver-in-the-ear (RITE) or completely-in-the-canal (CIC) type hearing devices or some combination of the above. Throughout this disclosure, reference is made to a “hearing device” or “ear-wearable device,” which is understood to refer to a system comprising a single left ear device, a single right ear device, or a combination of a left ear device and a right ear device.

Acoustic feedback occurs due to the acoustic coupling of the hearing aid receiver 103 and at least one of the microphones 110, 112, 114, creating a closed loop system. The term feedback is often associated with instability once the feedback reaches a threshold level, however low levels of feedback may exist in a stable system. A feedback path is an acoustic coupling path between receiver and microphones. Examples of feedback paths 120-122 are indicated by bold lines in the figure. Note that feedback can occur between any microphone 110, 112, 114 and the receiver 103, and the use of only one of the reference numbers 110, 112, 114 in subsequent diagrams is not meant to limit the embodiments to only one of the illustrated microphones.

The hearing device 100 includes one or more proximity sensors 124, 126. Proximity sensor 124 is located within the in-ear portion 102 and proximity sensor 126 is located within the external portion 106. The location of the proximity sensors 124, 126 may differ from what is shown. For example, a proximity sensor may instead or in addition be included with the in-ear portion 102 but face inwards towards the ear canal 104. In this way, the proximity sensor can be used to detect proximity between the in-ear portion 102 and surrounding ear structures, which can provide indications of how well the in-ear portion 102 is fit in the ear canal 104, when the in-ear portion is being inserted or removed, etc. This fit measurement is also relevant to feedback path estimation.

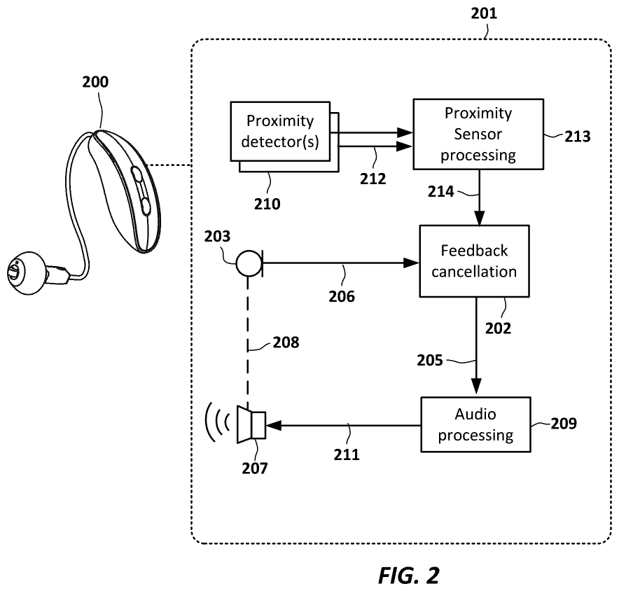

In FIG. 2, a block diagram shows the implementation of one or more proximity detectors 210 in a hearing device 200 according to an example embodiment. Block 201 represents hardware, firmware, and software components operable on the hearing device 200, including one or more microphones 203 and a receiver 207. A feedback cancellation circuit 202 monitors the signal 206 from the microphone 203 and estimates a feedback component of signal originating from the receiver 207 that is transmitted to the microphone 203 via a feedback path 208. The feedback cancellation circuit 202 subtracts the feedback component from the microphone signal 206, producing a feedback cancelled signal 205 that can be further processed by an audio processing circuit 209.

The audio processing circuit 209 provides an output signal 211 to the receiver 207. For a hearing aid application, the output signal 211 may include ambient sound sensed via the microphone 203 and further processed, e.g., amplified and enhanced to compensate for hearing loss. In some applications, the output signal 211 may include different or additional audio sources, such as indicator tones, digital sound (e.g., music, audio book) and other sound processing effects or components (e.g., spectral shaping to compensate for hearing loss, active noise cancellation).

A proximity sensor processing circuit 213 receives signals 212 from the proximity sensors 210 and processes the signals 212 to provide inputs 214 to the feedback cancellation circuit 202. This processing involves analog and digital signal processing such as analog-to-digital conversion, filtering, amplification, noise reduction, etc. The processing by circuit 213 may also include extraction of features or other characteristics of the proximity signals 212. For example, the inputs 214 may include detection of an event that triggers changing a step size of an adaptive filter used by the feedback cancellation circuit 202 due to possible significant changes in the feedback path.

Note that the feedback cancellation circuit 202, proximity sensor processing circuit 213, and audio processing circuit 209 may share common components, such as input preamplifiers, output amplifiers, analog-to-digital converters (ADC), digital-to-analog converters (DAC), digital signal processors (DSP), amplifiers, digital and analog filters, etc. At least some of the functionality may be implemented via firmware and/or software, which provides instructions to one or more general-purpose or special-purpose processors.

Generally, a proximity detector 210 can detect an object proximate to but not in contact with the hearing device 200 that houses the proximity sensor 210. The proximity sensor 210 may also generally detect an object that is in contact with the hearing device 200 and/or proximity sensor 210, however it is the former capability that distinguishes the proximity sensor from other sensors, such as contact switches, pressure sensors, etc., that can detect contact but not proximity.

The proximity sensors 210 may be of at least two different types. A first type emits signals through the air and measures the reflections via a receiver or detector. Characteristics of the reflections from an object (e.g., time of flight, intensity) can be used to calculate a proximity of the object. The emitted signals can be audio (e.g., ultrasonic), radio and/or optical signals. For hearing device application, an optical proximity sensor is considered suitable due to its low power, small size, and low cost.

Optical proximity sensors work by shining a light (e.g., invisible near-IR) and detecting a reflected signal from the same wavelength as the light emission. The working principle of one type of optical proximity sensor is to measure the reflected signal and depending on the amplitude of the reflected signal, determine the distance to an object. For very far away objects the reflected signal will be vanishingly small, at some distance away an object will start to reflect just enough photons such that the signal starts to increase. As the object gets closer and closer the signal amplitude will continue to increase until it comes into contact with the sensor. For soft objects like skin, some of the photons penetrate and scatter around inside before being reflected back to the sensor and the signal can continue to rise even after contact as more pressure is exerted against the sensor.

Optical proximity sensors can utilize ambient light cancellation techniques so that the sensors can be used in reasonably conceivable environments (bright, dark, outdoor with time varying light levels like walking through a forest with fast transitions between light and shadows). Techniques for improving optical sensor performance include IR passband optical filters, and digital ambient light subtraction. Passband filters stop any light from entering the detector by reflecting or absorbing any wavelength of light other than the wavelength of the light emission device. This reduces the amount of noise from ambient light getting into the detector. Digital ambient light subtraction works by taking a sample measurement with and without the emission light on in quick succession (within microseconds of each other) and subtracting the results. By subtracting the ambient signal within microseconds of the true measurements, ambient noise can be reduced, although not entirely since the ambient conditions could have slightly changed in those few microseconds.

The sampling time for a pulse of IR light can be as short as a few microseconds or could be on for a longer period for more accurate ADC readings. The longer the sample though the more chance there is for the ambient condition to change so there is a tradeoff of increasing ADC accuracy with decreasing ambient light cancelation ability.

For proximity applications that only require binary detection of an object the sampling period can be as long as 125 ms which creates a very low duty cycle for the LED to be on resulting in a very low power sensor. If fast moving objects and analog resolution for how close the object is required, then the sampling frequency can be increased to as high as 10 kHz. An example of an optical proximity sensor is the AMS TMD2636 which is 2.0×1.0×0.4 mm and has an average power draw of 6 μW.

A second type of proximity detector measures the effects of a proximate object on a field, e.g., an electromagnetic field. Capacitive sensors are an example of this second type of proximity detector. These sensors have slightly higher average currents than proximity sensors, but can also detect objects at a distance. These sensors work on the principal of capacitance change when the dielectric path that forms the capacitor changes when an object is nearby. This involves the dielectric path of the capacitor extending outside of the device such that the fringe fields are far enough away to detect the object of interest.

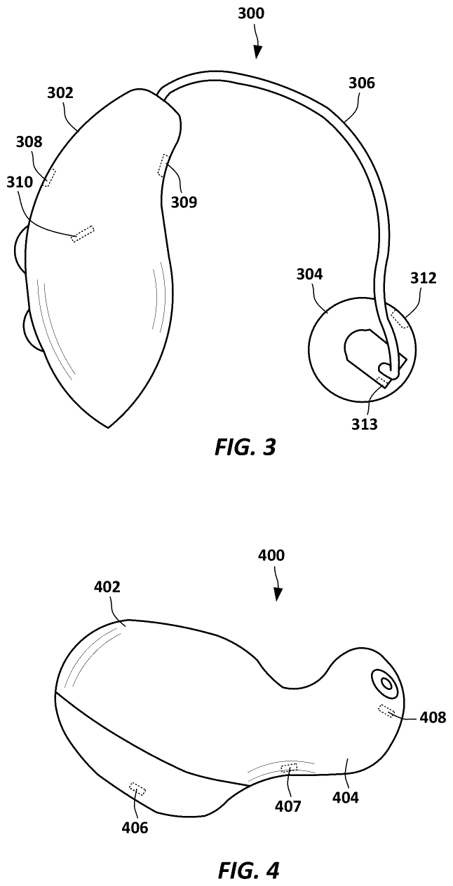

For some applications, a single, strategically placed proximity sensor can detect a wide variety of events useful for improving FBC processing. However, a plurality of physically separated proximity sensors can capture a more complex representation of the surrounding environment, thereby enabling a more accurate detection of events as well as expanding the possibly types of events that may be detected. In FIGS. 3 and 4, outside views of hearing devices 300, 400 indicate proximity sensor locations according to various embodiments. Any combination of locations shown in FIGS. 3 and 4 may be used for placing proximity sensors in each of the respective hearing devices 300, 400.

The hearing device 300 in FIG. 3 is a RIC device, with an external, BTE, portion 302 and an in-ear portion 304 coupled via a cable 306. The external portion 304 shows potential proximity sensor locations 308-310 on a respective top, bottom and side. The in-ear portion 304 shows potential proximity sensor locations 312, 313 on respective inward-facing and outward-facing parts. A proximity sensor at bottom location 309 inward facing location 312 can be in contact with the user's ear or head when properly fitted, therefore usable to detect fit and/or disturbances that affect the fit as well as a magnitude of disturbance or dislodgement. This is also the case with of the side location 310 if the sensor is facing the user's head. A proximity sensor at top location 308 and outward facing location 313 can detect proximity of outside objects, e.g., clothing, glasses, etc. This is also the case with side location 310 if the sensor is facing away from the user's head.

The hearing device 400 in FIG. 4 is an ITE or ITC device, with an outward facing portion 402 and an in-ear portion 404 housed in a single case. Potential proximity sensor locations include an outward facing location 406, a downward or upward facing location 407 outside the ear, and an inward facing location 408. Locations 407 and 408 can be in contact with the user's ear or head when properly fitted, therefore usable to detect fit and/or disturbances that affect the fit as well as a magnitude of disturbance or dislodgement. Location 406 can detect proximity of outside objects, e.g., clothing, glasses, etc.

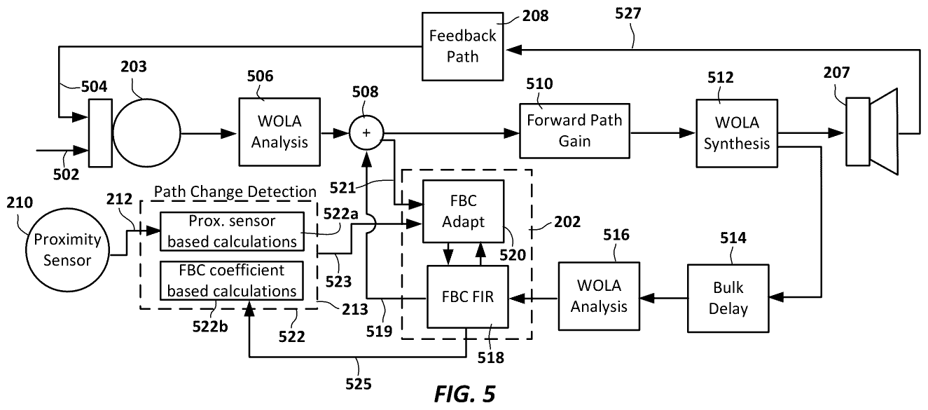

In FIG. 5, a block diagram shows a processing diagram of a hearing device that integrates a proximity sensor according to an example embodiment. The diagram in FIG. 5 uses the same references numbers for a feedback canceller 202, microphone 203, receiver 207, feedback path 208, proximity sensor 210, and proximity sensor processor 213 that were used in FIG. 2. The microphone 203 receives both source inputs 502 (e.g., ambient sound) and feedback inputs 504. A weighted overlap add (WOLA) block 506 converts the incoming microphone signals to a frequency domain data stream, the output of block 506 being combined with the output of the feedback canceller 202 at block 508. Block 510 applies gains onto the signal to enhance overall audio quality. WOLA synthesis block 512 performs a frequency to time domain conversion, providing an output signal to the receiver 207.

The time domain output signal from WOLA synthesis block 512 is also input to a bulk delay 514 to accommodate the feedback path length limitations of a finite impulse response (FIR) filter 518 used for feedback estimation. WOLA analysis block 516 receives the delayed time domain signal from the bulk delay 514 and coverts it to the frequency domain. The frequency domain signal from the WOLA analysis block 516 is input to the FIR filter 518 of the feedback canceller 202. Adaptive block 520 uses an adaptive algorithm, such as the least mean squares (LMS) algorithm, to tune the coefficients of the FIR filter 518.

The output of the FIR filter 518 is a noise cancellation signal 519, also referred to as an anti-noise signal. The cancellation signal 519 is an inverse of an estimate of the feedback signal. The feedback signal produced from the receiver acoustic output 527 transmitted via the feedback path 208 into the microphone 203. There will be a delay between the onset of the signal 527 and when it is picked again as feedback and transmitted by the microphone 203 together with source input 502. This delay is due to the forward processing latency and the length of the feedback 208.

In this example, the adaptive block 520 also receives a signal 523 from the proximity sensor processor 213, which in this example includes a path change detector 522. The path change detector 522 detects characteristics of proximity detector signal 212 indicative of a change in feedback path. If the change in feedback path meets a threshold and/or satisfies some other criterion (e.g., matches a known pattern), the path change detector sends an indication via the signal 523 to the adaptive block 520 to make changes to the FIR filter 518. As indicated by signal 525, the FIR filter 518 also can affect operation of the path change detector 522.

The path change detection block 522 comprises two distinct parts 522a-b. The first part 522a utilizes proximity sensors to gather sensor data, subsequently comparing it against a predefined threshold to identify objects in close proximity. Concurrently, a path tracker 522b is employed, involving a comparison of FBC adaptive filter coefficients against the FBC initialization. This dual-check mechanism ensures a robust verification of path alterations. Upon the confirmation of a path change by both components 522a-b, the settings of the FBC adapt block are dynamically adjusted.

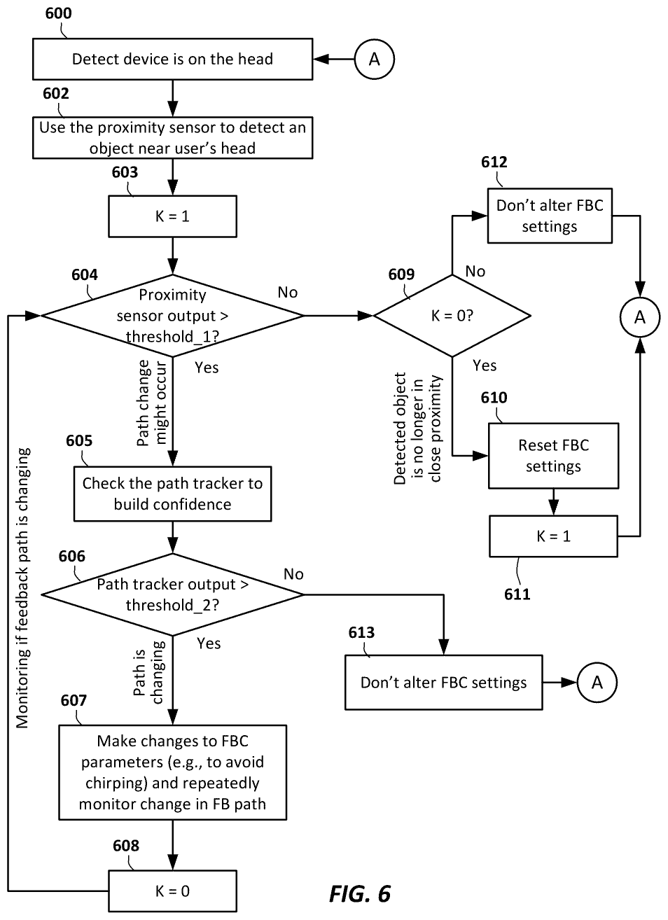

Signal 525 transfers the currently estimated FBC coefficients from the adaptive filter 520. These are used in the path change detector 522 to verify significant deviations of the coefficients against the last best known initialization of the feedback canceller. (see, e.g., block 605 in FIG. 6). Signal 523 controls the step-size of the adaptive filter 520 to be more aggressive (e.g., increased) when an object is moved towards the ear and less aggressive (e.g., decreased) when no object is close to the ear. The amount of this change could be on the order of a factor of 4, 8 or 16. Similarly signal 523 could be pointed into 510 as a gain modification mechanism. The extend of the gain reduction in response to an object close to the ear may involve some training of distance and chirp-risk from, for example, a dummy head to control. This could be similarly done for the step-size but the step-size can be set more intuitively. The gain modifications could be frequency specific, e.g., affecting frequencies more likely to be affected by the object and/or frequencies more likely to induce instability into the system. Wideband or Frequency-specific gain changes are an example of changing a model of the feedback path used by the feedback canceller. Another example of changing the model could be changing an estimate of delay along the feedback path.

The illustrated system can improve detection feedback path changes and adaptation of hearing aid settings accordingly before such changes can impact the performance of the feedback cancellation algorithm, e.g., lead to undesired chirping or howling. This is facilitated by the integration of the proximity sensors to identify potential disturbances, enabling the hearing aid to anticipate shifts and make instant adjustments. The signal obtained from the proximity sensor triggers changes to the hearing aid processing, e.g., adaptive feedback canceller step-size and/or hearing aid gain, to prevent undesired chirping sounds, ensuring uninterrupted auditory experiences.

The control of the step-size of the adaptive feedback canceller 202 in response to the proximity sensor output can be one of several ways. For example, if an object is detected the learning rate/step-size used by the adaptive filter components 518, 520 is increased temporarily by, e.g., a factor of 4, 8, 16. In another example, a machine learning algorithm, e.g., a deep neural network, could be trained to predict the risk of chirping from the output of the multitude of proximity sensors and cause the learning rate/step-size changes to be more gradual. Similarly, based on the proximity sensor output, the hearing aid gain can be controlled, e.g., it can be reduced by a predefined value if an object is detected in close proximity. The gain can be increased to the previous value once the proximate environment stabilizes.

In some embodiments, a machine learning algorithm, e.g., a deep neural network, could be trained to predict the risk of chirping from the output of the multitude of proximity sensors and allow more gradual control of the hearing aid gain. Such machine learning algorithm may use the output of the proximity sensors, e.g., distance, speed of movement, (in combination with the audio signals) to predict, e.g., a gain adjustment, the risk of chirping, the gain margin, which can be subsequently used to adjust the hearing aid gain.

The combination of proximity sensors and FBC parameter update adaptive algorithm forms a proactive feedback prevention mechanism. It provides insights into the immediate environment, allowing for proactive informed decisions for optimal hearing aid performance. This approach establishes a solution that can enhance user comfort, sound quality, and overall satisfaction. Consequently, these implementations have the potential to reshape how individuals with hearing impairments engage with their acoustic surroundings.

In other embodiments, proximity sensors could be utilized to monitor the appropriateness of the physical fit of the device in the ear. When the fit is improper, the value of a signal provided by the proximity sensors will deviate from what is expected. For example, a proximity sensor may provide a value that indicates the hearing device is not in close contact with the skin at a location where close contact is expected. Accordingly, it may be determined that the fit is poor based on the value provided by the proximity sensor. In a more optimally sealed fit, the proximity sensor would be in direct contact with the skin. Therefore, when the fit is poor, the output of the proximity sensor decreases, allowing us to distinguish between a good fit and a bad fit.

If an inappropriate fit is detected, the algorithm could provide a warning to the clinician/user. This can be used to help guide/teach the patient how to properly insert a new device. Alternatively, the hearing device could only be turned on after proper insertion into the patient's ear, thus eliminating feedback artifacts associated with the insertion of the device.

In FIG. 6, a flowchart shows a method according to an example embodiment. The method is in use when the hearing device is on the user's head, as indicated by block 600. Block 600 may be implemented as a wait state that holds until the device is detected on the head, and then passes control thereafter to the rest of the flowchart until the device is removed from the head. At block 602, a proximity sensor signal is monitored to detect whether an object is near the user's head, e.g., within some distance where the sensor can detect objects with high confidence. A status variable K is initialized at block 603 to ‘1,’ indicating no changes have been made yet to the FBC, e.g., changes to an adaptive algorithm for FBC filter. If K is set to ‘0’ (e.g., at block 608), then changes have been made to the FBC algorithm in response to an event detected by the proximity detector.

At block 604, the proximity detector signal is compared to a first threshold. If the signal exceeds the first threshold or otherwise satisfies a comparison with the threshold (e.g., exceeds a magnitude of the signal, rate of change, moving average of the signal, distance represented by the signal, machine learning model confidence level, etc.), then this is used as an initial indicator of a feedback path change. In response to the initial indicator, additional monitoring (e.g., path tracker computation) is performed at block 605 to determine with a final level of confidence that a feedback-path-altering event is occurring, and optionally that the nature of the event can be estimated (e.g., hearing device removed or inserted, contact by external object, location of contact, external object is soft or hard, etc.).

The additional monitoring 605 will examine at least the proximity detector signal to determine the feedback path is changing. The additional monitoring 605 may also involve examining other signals (e.g., inertial measurement unit, microphone, etc., as described elsewhere herein) to determine the feedback-path-altering event has occurred. This can avoid having to multiple sensor signals during the majority of time when no feedback events satisfy the first threshold.

If the path tracker determines the feedback path is changing (block 606 returns ‘yes’), then changes are made to the FBC at block 607, and the value of K is set to ‘0.’ Block 607 may also represent a wait state or monitoring state in which the proximity detector signals are monitored for a pattern indicative of a change in the feedback path. If this change results in the threshold determined at block 604 going below the first threshold, this results in control being passed to block 609, Assuming the feedback controller was altered to compensate for a feedback path change (K=‘0’), then the feedback controller settings are reverted at block 610, e.g., to a default or previously used setting. The value of K is reset at block 611. Note that blocks 612 and 613 represent situations where the feedback controller was not previously altered, in which no changes are made to the feedback controller settings.

In some embodiments, a machine-learning algorithm may be used to process proximity sensor signals for purposes of detecting events that are likely to lead to changes in feedback path. Machine-learning involves inputting actual and/or simulated data into a data structure (e.g., a neural network, state vector machine) that looks for patterns that match some criteria. For example, if a set of data (e.g., time varying proximity sensor data) exists that has been previously labeled (e.g., classifications, features), then supervised learning may be used to determine a transformation between the input data and the output data (e.g., object is nearby, device is being removed from ear). Unsupervised learning may be used without labeled data. For example, a state vector machine (SVM) may analyze data that has been segmented into time-dependent sequences and classify the segments into two or more categories due to similarities between sequences. In embodiments described above, a machine learning model may be employed as a path tracker that is triggered after an initial proximity detection event that satisfies a threshold is determined.

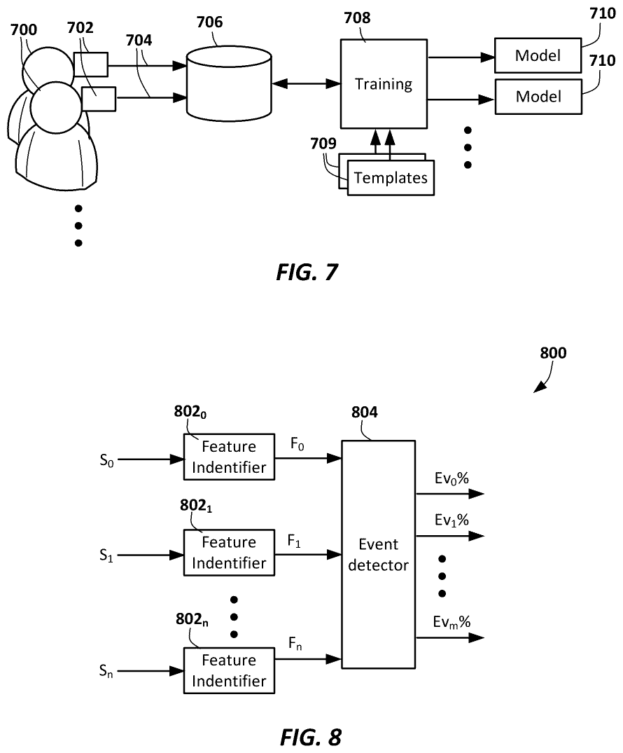

In FIG. 7, a block diagram shows training of a machine learning model for proximity sensor data according to an example embodiment. In this example, a population of testers 700 uses respective hearing devices 702 during a testing phase, during which data 704 is gathered and stored in a database. The hearing devices 702 may be functionally equivalent to a target hearing device (e.g., same model and version) or a variety of device models/configurations may be used. The data 704 may at least include proximity sensor data gathered from sensors integrated into the devices 702, and may include other device-collected data such as inertial measurement data, biometric data, and adaptive feedback filter statistics. The data 704 may also include other data obtained externally, such as videos or logs that record the times of certain definable events (e.g., hearing device insertion and removal).

Once sufficient data 704 has accumulated in the database 706, a training algorithm 708 can be applied to one or more templates 709 to produce one or more trained models 710. In this context, a template 709 (also referred to as hyperparameters) is a definition of a type and structure of model, such as a recurrent neural network (RNN) with long short-term memory (LSTM) recurrent units, X-dimensional input, and Y-dimensional output. Templates 709 can include non-neural network machine-learning models, such as SVM and hidden-Markov models (HMM). The training algorithm 708 determines weights of the neural network through optimization, e.g., backpropagation using gradient descent, thus the trained models 710 can include a data structure that stores the trained network weights and metadata that describes the applicable template 709.

Note that the training algorithm may include many algorithms that focus on different aspects of the collected data. For example, some machine learning models may be trained to identify a predefined number of features in a time-domain signal. In use, each of these features may be detected in parallel from multiple proximity sensors, as in relation to FIG. 8, which shows a machine-learning model 800 according to an example embodiment. This embodiment can jointly analyze multiple proximity sensors and other sensors to determine effects on the feedback path.

Sensor inputs S₀-Sₙ are fed into to respective feature identifier models 802₀-802ₙ, which output respective features F₀-F₁. At least some of the sensor inputs S₀-Sₙ are from proximity sensors, however other non-proximity sensors may be also considered, such as a microphone, an inertial measurement unit, biometric sensors (e.g., heart rate), vibration sensors, magnetic field sensors, etc. Generally, when the sensor inputs S₀-Sₙ are time dependent signals, the models 802₀-802ₙ are selected which are suitable for time domain data, such as RNNs. The features F₀-F₁ may be automatically identified and determined via unsupervised learning.

Note that each feature identifier model 802 may be trained to output a different feature F, or each model 802 may be trained out output a plurality of features at the same time. In the latter case, the features F₀-F₁ are feature vectors. The features F₀-F₁ are fed into an event detector 804 that may detect one or more different events Ev₀-Evₘ. The event detector 804 may detect/learn time-based and/or sequence-based correlations between feature sequences from multiple sensors. The event detector 804 may also use an RNN or some type of feedforward neural network, such as a convolutional neural network (CNN). This type of machine learning model may provide a more detailed and nuanced view of the sensor signals, thereby potentially increasing a confidence level of predictions relevant to feedback path changes.

Note that the events Ev₀-Evₘ may be explicitly understood as conforming to particular behaviors (e.g., taking off a hat, taking out the device from the ear canal) and\or may be empirically mapped to different aspects of feedback path change. In other embodiments, the events may be uncorrelated to any particular event. For example, each output may correspond to a probability that a particular setting change will alleviate feedback effects. Some settings that could be affected in this way include changes in feedback transfer function or other FBC parameter, and changes to gain. The events Ev₀-Evₘ may be a vector of probabilities in this latter case, and the probabilities need not add to one.

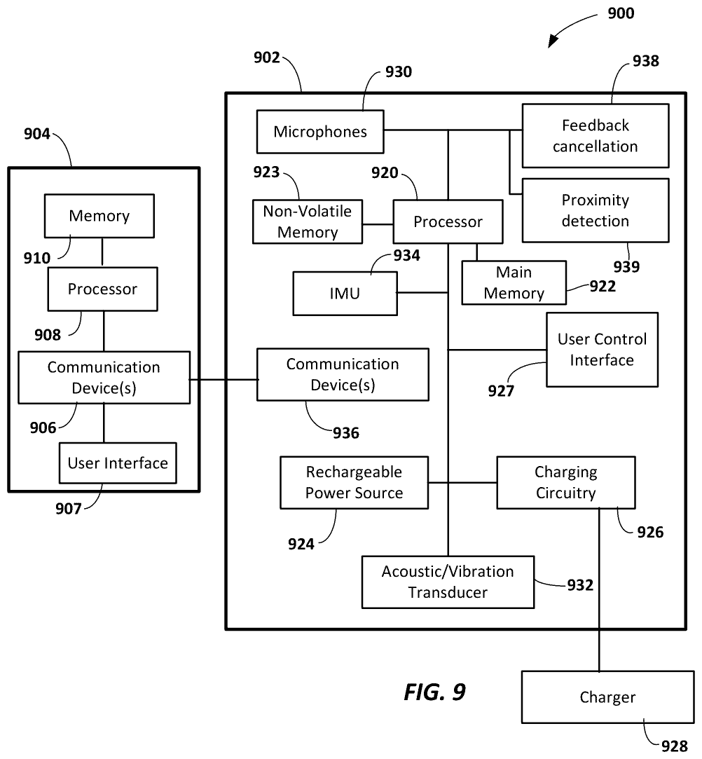

In FIG. 9, a block diagram illustrates a system and ear-worn hearing device 900 in accordance with any of the embodiments disclosed herein. The hearing device 900 includes a housing 902 configured to be worn in, on, or about an ear of a wearer. The hearing device 900 shown in FIG. 9 can represent a single hearing device configured for monaural or single-ear operation or one of a pair of hearing devices configured for binaural or dual-ear operation. The hearing device 900 shown in FIG. 9 includes a housing 902 within or on which various components are situated or supported. The housing 902 can be configured for deployment on a wearer's ear (e.g., a behind-the-ear device housing), within an ear canal of the wearer's ear (e.g., an in-the-ear, in-the-canal, invisible-in-canal, or completely-in-the-canal device housing) or both on and in a wearer's ear (e.g., a receiver-in-canal or receiver-in-the-ear device housing).

The hearing device 900 includes a processor 920 operatively coupled to a main memory 922 and a non-volatile memory 923. The processor 920 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 920 can include or be operatively coupled to main memory 922, such as RAM (e.g., DRAM, SRAM). The processor 920 can include or be operatively coupled to non-volatile (persistent) memory 923, such as ROM, EPROM, EEPROM or flash memory. As will be described in detail hereinbelow, the non-volatile memory 923 is configured to store instructions (e.g., module 938) that detect and mitigate feedback.

The hearing device 900 includes an audio processing facility (also referred to as an audio processor circuit) operably coupled to, or incorporating, the processor 920. The audio processing facility includes audio signal processing circuitry (e.g., analog front-end, analog-to-digital converter, digital-to-analog converter, DSP, and various analog and digital filters), a microphone arrangement 930, and an acoustic/vibration transducer 932 (e.g., loudspeaker, receiver, bone conduction transducer, motor actuator). The microphone arrangement 930 can include one or more discrete microphones or a microphone array(s) (e.g., configured for microphone array beamforming). Each of the microphones of the microphone arrangement 930 can be situated at different locations of the housing 902. It is understood that the term microphone used herein can refer to a single microphone or multiple microphones unless specified otherwise.

At least one of the microphones 930 may be configured as a reference microphone producing a reference signal in response to external sound outside an ear canal of a user. Another of the microphones 930 may be configured as an error microphone producing an error signal in response to sound inside of the ear canal. The acoustic transducer 932 produces amplified sound inside of the ear canal.

The hearing device 900 may also include a user interface with a user control interface 927 operatively coupled to the processor 920. The user control interface 927 is configured to receive an input from the wearer of the hearing device 900. The input from the wearer can be any type of user input, such as a touch input, a gesture input, or a voice input. The user control interface 927 may be configured to receive an input from the wearer of the hearing device 900.

The hearing device 900 also includes a feedback cancellation module 938 operably coupled to the processor 920. The module 938 can be implemented in software, hardware (e.g., digital signal processor, general purpose processor), or a combination of hardware and software. During operation of the hearing device 900, the module 938 utilizes proximity data provided by a proximity detection module 939. The proximity detection module 939 includes or is coupled to a proximity sensor operable to detect an object proximate to but not in contact with the hearing device 900 (and also may be capable of detecting contact between the object and hearing device 900). The proximity detection module 939 works in cooperation with the feedback cancellation module 938 to detect, via the proximity sensor, a relative movement between the object and the hearing device 900. The modules determine that the relative movement will affect a feedback path between the receiver 932 and the microphone 930. In response thereto, a parameter affecting the feedback canceller 938 is used to cancel feedback through a feedback path.

The proximity detection module 939 and the feedback cancellation module 938 may utilize other sensors of the hearing device 900. For example, the device 900 may include an inertial measurement unit (IMU) 934 that can detect orientation of the hearing device 900 and may also be indicative of a change in feedback. Other functional modules of the device may interact with the IMU 934 to determine an operating context of the hearing device 900, e.g., in-ear, out-of-ear, etc., which be used to enhance predictions made by the proximity detector 939 and feedback canceller 938. Audio signals detected by the microphones 930 can be similarly used by the proximity detector 939 to enhance detection of proximity events.

In one or more embodiments, the proximity detection module 939 can operate with the gesture tracking described above as optionally being part of the user control interface 927. The previously described proximity sensors (e.g., sensor 210 in FIG. 2) could be used to sense gesture, e.g., if a hand is moving from front-to-back, back-to-front, top-to-bottom, bottom-to-top, etc. While one movement maybe considered just the opposite of another, the resulting feedback path trajectory for one direction can be too fast for the feedback canceller to handle while the opposite direct may be within the ability of the feedback canceller to adjust to. Thus the proximity detection module 939 may use or provide classification of different gestures, and the identified gesture classes can be used to adapt or adjust the feedback cancellation module 938.

The hearing device 900 can include one or more communication devices 936. For example, the one or more communication devices 936 can include one or more radios coupled to one or more antenna arrangements that conform to an IEEE 902.9 (e.g., Wi-Fi®) or Bluetooth® (e.g., BLE, Bluetooth® 4.2, 5.0, 5.1, 5.2 or later) specification, for example. In addition, or alternatively, the hearing device 900 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 936 may also include wired communications, e.g., universal serial bus (USB) and the like.

The communication device 936 is operable to allow the hearing device 900 to communicate with an external computing device 904, e.g., a mobile device such as smartphone, laptop computer, etc. The external computing device 904 may also include a device usable by a clinician in a clinical setting, such as a desktop computer, test apparatus, etc. The external computing device 904 includes a communications device 906 that is compatible with the communications device 936 for point-to-point or network communications. The external computing device 904 includes its own user interface 907, processor 908, and memory 910, the latter which may encompass both volatile and non-volatile memory.

The hearing device 900 also includes a power source, which can be a conventional battery, a rechargeable battery (e.g., a lithium-ion battery), or a power source comprising a supercapacitor. In the embodiment shown in FIG. 9, the hearing device 900 includes a rechargeable power source 924 which is operably coupled to power management circuitry for supplying power to various components of the hearing device 900. The rechargeable power source 924 is coupled to charging circuitry 926. The charging circuitry 926 is electrically coupled to charging contacts on the housing 902 which are configured to electrically couple to corresponding charging contacts of a charger 928 when the hearing device 900 is placed in the charger.

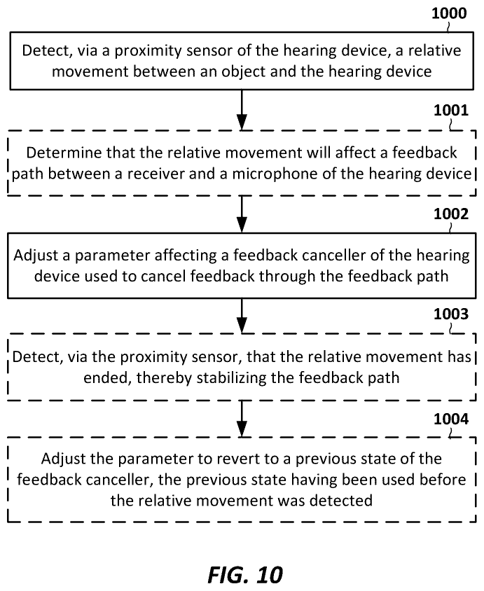

In FIG. 10, a flowchart shows a method of operating a hearing device according to an example embodiment. The method involves detecting 1000, via a proximity sensor of the hearing device, a relative movement between an object and the hearing device. The proximity sensor is operable to detect objects proximate to but not in contact with the hearing device. The hearing device optionally determines 1001 that the relative movement will affect a feedback path between a receiver and a microphone of the hearing device. Note that the system need not explicitly calculate a change in feedback path, and some models (e.g., machine learning models) can directly infer that some relative movements will change the feedback canceller, whether or not there is a significant change in feedback path. In response to the determination 1001, a parameter is adjusted 1002 that affects a feedback canceller of the hearing device used to cancel feedback, and compensates for the relative movement detected at block 1000.

Optionally, the method may involve detecting 1003, via the proximity sensor, that the relative movement has ended, thereby stabilizing the feedback path. In such a case, the parameter can, in response to the detection 1003, revert 1004 to a previous state of the feedback canceller. The previous state is one that was been used or defined before the relative movement was detected, e.g., a prior state setting, a default setting, etc. Note that in some cases the relative movement may stabilize in situations such as the relative velocity between the proximity sensor and the object being constant. The feedback path will not have stabilized in such a case, and so the previous state will not be entered until the feedback path is stabilized.

In summary, the embodiments described herein tackle challenges in dealing with acoustic feedback and changes in the acoustic feedback path. Using proximity sensors and FBC parameter update adaptive algorithm, the proposed solutions offer a proactive strategy against feedback and rapid adaptations to feedback path shifts. The following is a summary of some features of the hearing devices disclosed in embodiments above.

The hearing device includes one or more proximity sensors and utilizes the output of the proximity sensors to sense the presence of an object close to the hearing device. This monitoring can be implemented as a continuous monitoring process that gauges the proximity of objects adjacent to the user's ear that may potentially alter the acoustic feedback path. An object in close proximity to the feedback path can be detected by the sensor output surpassing a predetermined threshold which indicates an impending change in the feedback path. Because the proximity sensor can predict a feedback path change before it occurs, the system can more gradually adapt than if the changes were detected after the path changes.

Upon confirmation of an imminent or present feedback path alteration through the path change detector, adjustments can be applied to the feedback canceller to compensate for the alteration. Such adjustment includes, for example increasing the adaptation rate of the adaptive filter or reducing the hearing aid gain when the feedback path is changing and the risk of occurrence of chirping is increased. The device can revert back to a previously last known state of the feedback canceller and/or hearing aid gain, once the feedback path has stabilized.

For detecting object proximity, a subsequent validation process can be executed by the path change detector, adding an extra layer of certainty to the detection process. The threshold values for the proximity sensors can be tailored to the individual user and even dynamically adjusted over time. For instance, users who frequently interact with their hearing aids might encounter frequent feedback changes. In such cases, the threshold of the proximity sensor-based path change detector can be elevated to account for this interaction frequency. This personalized threshold calibration guarantees a finely tuned hearing aid system that skillfully aligns with each user's distinctive requirements and usage patterns.

Proximity sensors may be included on in-ear models and behind-the-ear (BTE) models. These proximity sensors can be employed either in isolation or in conjunction with each other. The proximity sensors can be used to determine movement of the hearing aid in relation to the user's head. The proximity sensors can be used to assess the hearing aid fit quality. The proximity sensors can be used to disable audio reproduction by the hearing device to mitigate chirping when user inserts or removes the hearing aids. A machine learning model may be trained to predict and adjust hearing aid gain reduction and/or adaptation rate based on the speed and frequency of feedback path changes.

This document discloses numerous example embodiments, including but not limited to the following:

Example 1 is a hearing device, comprising: a receiver, a microphone, and a proximity sensor operable to detect an object proximate to but not in contact with the hearing device. One or more processors of the device are coupled to the receiver, the microphone, and the proximity sensor. The one or more processors are operable to execute a feedback canceller that cancels feedback transmitted through a feedback path between the receiver and the microphone. The processors are further operable to: detect, via the proximity sensor, a relative movement between the object and the hearing device; and in response thereto, adjust a parameter affecting the feedback canceller of the hearing device to compensate for a change caused by the relative movement that affects the feedback canceller.

Example 2 includes the hearing device of example 1, wherein the parameter comprises an adaption rate of an adaptive filter used by the feedback canceller. Example 3 includes the hearing device of example 1 or 2, wherein the parameter comprises a gain of the hearing device. Example 4 includes the hearing device of any previous example, wherein the processors are further operable to: detect, via the proximity sensor, that the relative movement has ended; and in response thereto, adjust the parameter to revert to a previous state of the feedback canceller, the previous state having been used before the relative movement was detected.

Example 5 includes the hearing device of any previous example, wherein the proximity sensor is located on an out-of-ear portion of the hearing device. Example 6 includes the hearing device of example 5, wherein the out-of-ear portion of the hearing device comprises a behind-the-ear portion. Example 7 includes the hearing device of example 5, further comprising a second proximity sensor located on an in-ear portion of the hearing device and configured to detect proximity of an ear canal structure. Example 8 includes the hearing device of example 7, wherein signals from the proximity sensor and the second proximity sensor are jointly analyzed to determine the change that affects the feedback canceller.

Example 9 includes the hearing device of any previous example, wherein the proximity sensor is located on an in-ear portion of the hearing device and the object comprises an ear canal structure of a user. Example 10 includes the hearing device of example 9, wherein the relative movement is caused by the hearing device being placed on or removed from at least one of a head of the user or an ear of the user. Example 11 includes the hearing device of example 10, wherein adjusting the parameter comprises disabling audio reproduction by the hearing device. Example 12 includes the hearing device of example 9, wherein the processors are further operable to determine a fit quality of the hearing device within an ear canal of the user based on a proximity between the hearing device and the ear canal structure.

Example 13 includes the hearing device of any previous example, wherein the proximity sensor is further operable to detect the object in contact with the hearing device. Example 14 includes the hearing device of any previous example, wherein the processor is further operable to determine that the relative movement will change the feedback path, the parameter being adjusted to compensate for the change in the feedback path. Example 15 includes the hearing device of example 14, wherein determining that the relative movement will affect the feedback path comprises determining that the object is within a threshold distance of the hearing device. Example 16 includes the hearing device of example 14, wherein determining that the relative movement will affect the feedback path comprises inputting a signal from the proximity sensor into a neural network, an output of the neural network indicating an impact on the feedback path.

Example 17 includes the hearing device of any previous example, wherein the proximity sensor comprises an optical proximity sensor. Example 18 includes the hearing device of any previous example, wherein the proximity sensor comprises a capacitive proximity sensor. Example 19 includes the hearing device of any previous example, wherein the proximity sensor comprises at least one of a radio frequency proximity sensor and an ultrasonic proximity sensor.

Example 20 is a method of operating a hearing device, comprising: detecting, via a proximity sensor of the hearing device, a relative movement between an object and the hearing device, the proximity sensor operable to detect objects proximate to but not in contact with the hearing device; determining that the relative movement will affect a feedback canceller of the hearing device, the feedback canceller used to cancel feedback that is transmitted through a feedback path; and in response thereto, adjusting a parameter affecting the feedback canceller of the hearing device to compensate for the relative movement.

Example 21 includes the method of example 20, wherein the proximity sensor is further operable to detect the object in contact with the hearing device. Example 22 includes the method of example 20 or 21, wherein the parameter comprises at least one of an adaption rate of an adaptive filter used by the feedback canceller and a gain of the hearing device. Example 23 includes the method of any previous method example, further comprising: detecting, via the proximity sensor, that the relative movement has ended; and in response thereto, adjusting the parameter to revert to a previous state of the feedback canceller, the previous state having been used before the relative movement was detected.

Example 24 includes the method of any previous method example, wherein the proximity sensor is located on an out-of-ear portion of the hearing device and the object is outside of an ear canal of a user. Example 25 includes the method of example 24, wherein the hearing device comprises a second proximity sensor located on an in-ear portion of the hearing device, the method further comprising detecting proximity of an ear-canal structure via the second proximity sensor. Example 26 includes the method of example 25, further comprising jointly analyzing signals of the proximity sensor and the second proximity sensor to determine effects on the feedback canceller.

Example 27 includes the method of any previous method example, wherein the proximity sensor is located on an in-ear portion of the hearing device and the object comprises an ear canal structure of a user. Example 28 includes the method of example 27, wherein the relative movement is caused by the hearing device being placed on or removed from a head of the user. Example 29 includes the method of example 28, wherein adjusting the parameter comprises disabling audio reproduction by the hearing device. Example 30 includes the method of example 27, further comprising determining a fit quality of the hearing device within an ear canal of the user based on a proximity between the hearing device and the ear canal structure.

Example 31 includes the method of any previous method example, wherein determining that the relative movement will affect the feedback canceller comprises determining that the object is within a threshold distance of the hearing device. Example 32 includes the method of any previous method example, wherein determining that the relative movement will affect a feedback canceller comprises inputting a signal from the proximity sensor into a neural network, an output of the neural network indicating an impact on the feedback canceller. Example 33 includes the method of example 32, further comprising training the neural network on a data set comprising measurements made with a population of users employing respective hearing devices that are functionally equivalent to the hearing device.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety into this disclosure, except to the extent they may directly contradict this disclosure. Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g., 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electric signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list. The phrases “determined,” “detecting,” and the like in the context of a determination made by a device, apparatus, machine, or the like includes any combination of measurement, analog or digital signal processing, mechanical actuation, processor algorithms, and machine-learning structures and algorithms.

1. A hearing device, comprising:
a receiver, a microphone, and a proximity sensor operable to detect an object proximate to but not in contact with the hearing device; and
one or more processors coupled to the receiver, the microphone, and the proximity sensor, the one or more processors being operable to execute a feedback canceller that models a feedback path between the receiver and the microphone, the processors being further operable to:
detect, via the proximity sensor, a relative movement between the object and the hearing device;
determine that the relative movement will change the feedback path; and
in response thereto, adjust a parameter affecting the feedback canceller of the hearing device to compensate for a change caused by the relative movement that affects the feedback canceller, the parameter being adjusted to compensate for the change in the feedback path.

2. The hearing device of claim 1, wherein the parameter comprises one or more of an adaption rate of an adaptive filter used by the feedback canceller and a gain of the hearing device.

3. The hearing device of claim 1, wherein determining that the relative movement will change the feedback path comprises:
comparing a signal of the proximity detector to a first threshold to determine an initial indicator of a feedback path change; and
in response to the initial indicator, perform additional monitoring of the signal to determine with a final level of confidence that a feedback-path-altering event is occurring.

4. The hearing device of claim 3, wherein the additional monitoring of the signal comprises jointly analyzing the signal with at least one other signal from at least one other sensor different from the proximity sensor.

5. The hearing device of claim 4, wherein jointly analyzing the signal and the at least one other signal is performed via a neural network.

6. The hearing device of claim 1, wherein the processors are further operable to:
detect, via the proximity sensor, that the relative movement has ended; and
in response thereto, adjust the parameter to revert to a previous state of the feedback canceller, the previous state having been used before the relative movement was detected.

7. The hearing device of claim 1, wherein the proximity sensor is located on an out-of-ear portion of the hearing device.

8. The hearing device of claim 7, wherein the out-of-ear portion of the hearing device comprises a behind-the-ear portion.

9. The hearing device of claim 7, further comprising a second proximity sensor located on an in-ear portion of the hearing device and configured to detect proximity of an ear canal structure, wherein signals from the proximity sensor and the second proximity sensor are jointly analyzed to determine the change in the feedback path.

10. The hearing device of claim 1, wherein the proximity sensor is located on an in-ear portion of the hearing device and the object comprises an ear canal structure of a user, and wherein the relative movement is caused by the hearing device being placed on or removed from at least one of a head of the user or an ear of the user.

11. The hearing device of claim 10, wherein adjusting the parameter comprises disabling audio reproduction by the hearing device.

12. The hearing device of claim 1, wherein adjusting the parameter comprises changing the modeling of the feedback path.

13. The hearing device of claim 9, wherein the processors are further operable to determine a fit quality of the hearing device within an ear canal of a user based on a proximity between the hearing device and the ear canal structure.

14. The hearing device of claim 1, wherein the proximity sensor is further operable to detect the object in contact with the hearing device.

15. The hearing device of claim 1, wherein determining that the relative movement will affect the feedback path comprises inputting a signal from the proximity sensor into a neural network, an output of the neural network indicating an impact on the feedback path.

16. The hearing device of claim 15, wherein a second signal different a second sensor different from the proximity sensor is input into the neural network, the output of the neural network to jointly processing the signal and the second signal to indicate the impact on the feedback path.

17. The hearing device of claim 16, wherein the second sensor is a non-proximity sensor.

18. The hearing device of claim 1, wherein the proximity sensor comprises an optical proximity sensor, a capacitive proximity sensor, a radio frequency proximity sensor, or an ultrasonic proximity sensor.

19. A method of operating a hearing device, comprising:
detecting, via a proximity sensor of the hearing device, a relative movement between an object and the hearing device, the proximity sensor operable to detect objects proximate to but not in contact with the hearing device;
modeling, via a feedback canceller, a feedback path between a receiver and a microphone of the hearing device, the feedback canceller used to cancel feedback that is transmitted through the feedback path;
determining that the relative movement will change the feedback path; and
in response thereto, adjusting a parameter affecting the feedback canceller of the hearing device to compensate for the change in the feedback path.

20. The method of claim 19, wherein the proximity sensor is further operable to detect the object in contact with the hearing device.

21. The method of claim 19, wherein the hearing device comprises a second proximity sensor located on an in-ear portion of the hearing device, the method further jointly analyzing signals of the proximity sensor and the second proximity sensor to determine the change in the feedback path.

22. The method of claim 21, further comprising determining a fit quality of the hearing device within an ear canal of a user based on a proximity between the hearing device and an ear canal structure.

23. The method of claim 19, wherein determining that the relative movement will change the feedback path comprises:
comparing a signal of the proximity detector to a first threshold to determine an initial indicator of a feedback path change; and
in response to the initial indicator, jointly analyzing the signal the signal with at least one other signal from at least one other sensor different from the proximity sensor to determine with a final level of confidence that a feedback-path-altering event is occurring.

24. The method of claim 19, wherein determining that the relative movement will affect the feedback canceller comprises inputting a first signal from the proximity sensor and a second signal from a non-proximity sensor into a neural network, an output of the neural network indicating an impact on the feedback canceller based on jointly processing the first and second signals.
